(19) United States
(12) Patent Application Publication
(10) Pub. No.: US 2004/0202006 A1
(43) Pub. Date: Oct. 14, 2004

(54) Taillight with individually replaceable LED lamps

(76) Inventor: Shou-Wei Pien, Taipei (TW)

Correspondence Address: SEED INTELLECTUAL PROPERTY LAW GROUP PLLC, 701 FIFTH AVENUE, SUITE 6300, SEATTLE, WA, 98104-7092, US

(21) Appl. No.: 10/412,435

(22) Filed: Apr. 10, 2003

(51) Int. Cl. F21V 21/00

(52) U.S. Cl. 362/545; 362/544; 362/548

(57) ABSTRACT

A taillight mainly includes a pan for the taillight, a plurality of LED lamp bases separately connected to a conductor, and a plurality of LED lamps separately plugged into the LED lamp bases. The pan is provided with insertion holes in the same number as that of the LED lamp bases, so that the LED lamp bases are individually plugged into the insertion holes in a one-to-one correspondence. The LED lamps may be individually replaced to enable easy maintenance and repair at reduced cost.

### FIELD OF THE INVENTION

The present invention relates to a taillight, and more particularly to a taillight with individually replaceable LED lamps to enable easy maintenance and repair of the taillight at reduced cost.

### BACKGROUND OF THE INVENTION

For general people, a vehicle, such as a car, is only a traffic means or a business tool. However, there are car lovers who treat their cars as their most precious treasures. A car lover wants a car that has not only excellent performance, but also the most fashionable and eye-catching appearance.

To create a unique and modern visual impression for the car, the car-lover would usually paint the body of the car with different colors and patterns, mount a specially designed spoiler, or change the lamps to different shapes. A currently most welcomed design for a taillight includes a plurality of light-emitting diode (LED) lamps being controlled via a circuitry on a circuit board in the taillight. A disadvantage of this type of taillight with LED lamps is, when any one of the LED lamps is failed, a dark spot at the failed LED lamp is clearly seen from outside of the taillight when the same is lighted. The dark spot on the lighted taillight largely reduces the initial fashionable appearance and the valuable feeling of the car. Since the circuit board for the LED lamps is integrally connected to a pan of the taillight, it is impossible to repair the taillight simply by replacing the failed LED lamp. Instead, the whole taillight, including the circuit board and all the LED lamps thereof, must be replaced, which requires a considerably high repair cost.

It is therefore tried by the inventor to develop a taillight with individually replaceable LED lamps, so as to largely reduce the cost for repairing the LED lamps of the taillight.

### SUMMARY OF THE INVENTION

The taillight with individually replaceable LED lamps according to the present invention mainly includes a pan for the taillight, a plurality of LED lamp bases separately connected to a conductor, and a plurality of LED lamps separately plugged into the LED lamp bases. The pan is provided with insertion holes in the same number as that of the LED lamp bases, so that the LED lamp bases are individually plugged into the insertion holes in a one-to-one correspondence. Each of the insertion holes has a front portion formed into a flared spotlight shade, so that a unique pattern showing different colors may be formed from the a plurality of LED lamps in the flared spotlight shades and clearly viewed from outside of the taillight.

Moreover, the LED lamps for the taillight of the present invention are electrically connected in a predetermined manner to enable individual replacement thereof. That is, any failed LED lamp could be separately replaced to largely reduce the cost for repairing the taillight.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded front, perspective view of a taillight with individually replaceable LED lamps according to the present invention;

FIG. 2 is a rear plan view of a pan of the taillight of FIG. 1;

FIG. 3 is a fragmentary sectioned side view showing the plugging of an LED lamp base into an insertion hole on the pan of the taillight of the present invention;

FIG. 4 shows the LED lamp base of FIG. 3 with an LED lamp separated therefrom;

FIG. 5 is an exploded perspective view of the LED lamp of FIG. 4; and

FIG. 6 is an assembled front perspective view of the taillight with individually replaceable LED lamps according, to the present invention.

### DETAILED DESCRIPTION OF THE PREFERRED EMBODIMENTS

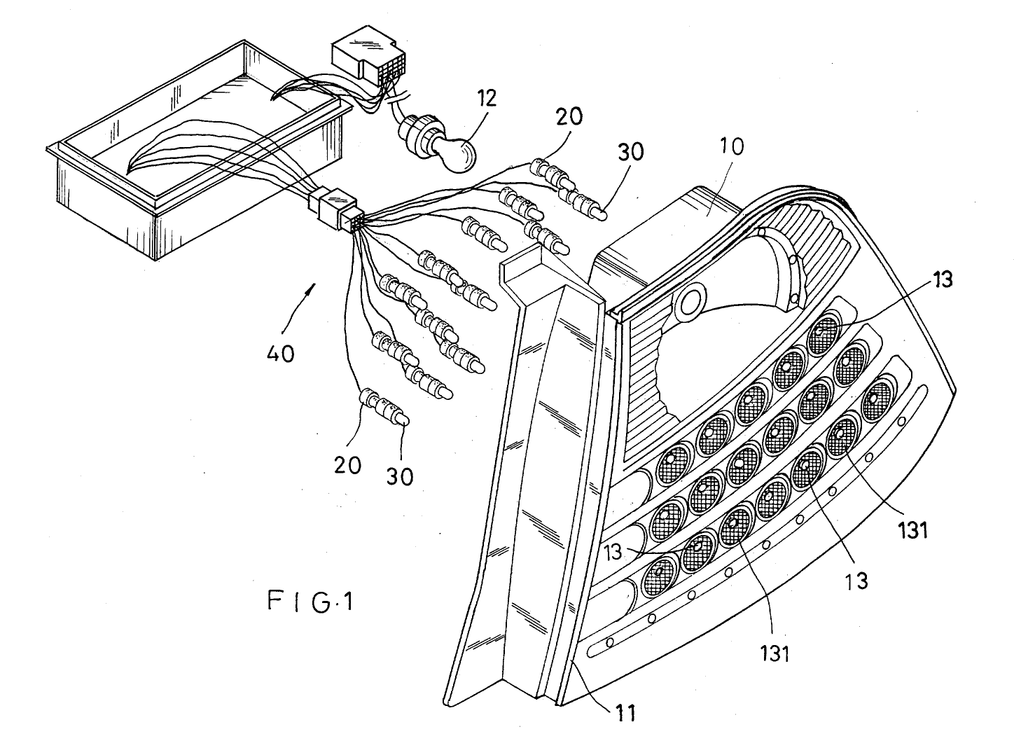

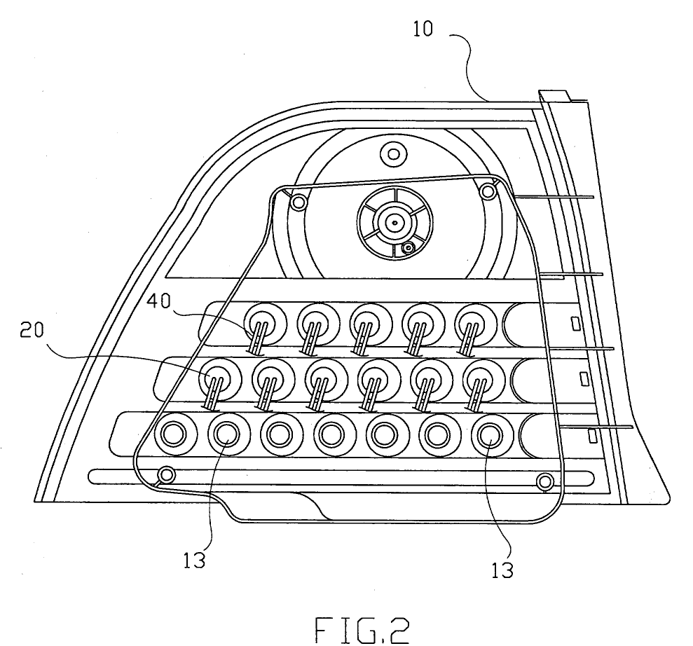

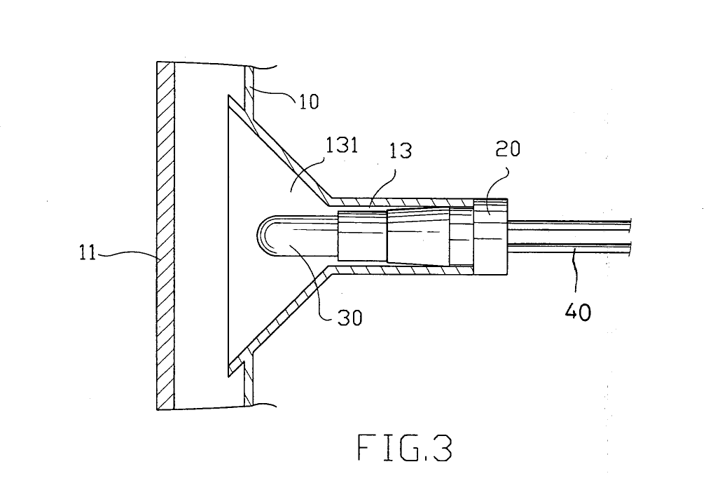

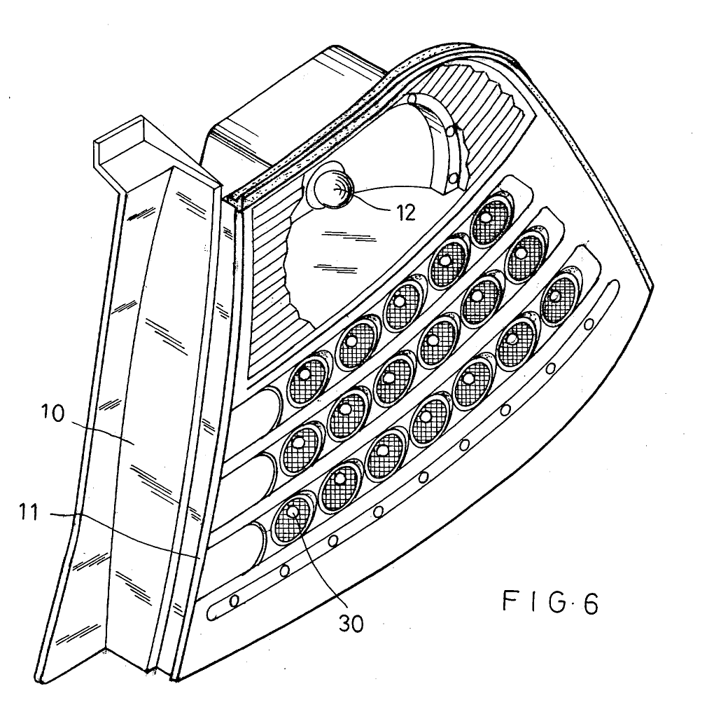

Please refer to FIGS. 1 and 6 that are exploded and assembled front perspective views, respectively, of a taillight with individually replaceable light-emitting diode (LED) lamps according to an embodiment of the present invention. As shown, the taillight of the present invention mainly includes a pan 10 for the whole taillight, a plurality of LED lamp bases 20, and a plurality of LED lamps 30. A transparent panel 11 is mounted on the pan 10 to close a front opening thereof. A bulb 12 is fixed on the pan 10 at a predetermined position. As can be seen from FIG. 2, that is a rear plan view of the pan 10, the pan 10 is provided with a plurality of insertion holes 13 in the same number as that of the LED lamps 30. Please refer to FIG. 3 that is a fragmentary sectioned side view showing the plugging of one LED lamp base 20 into one insertion hole 13 on the pan 10. As shown, each of the insertion holes 13 has a flared front portion that is formed into a spotlight shade 131. Each of the LED lamp bases 20 is plugged into a rear portion of one insertion hole 13 on the pan 10 to locate in place thereat. Each of the LED lamps 30 is plugged into one corresponding LED lamp base 20 with a front head of the LED lamp 30 projected into and centered at the flared spotlight shade 131 of the insertion hole 13. The LED lamp base 20 is then connected at a rear end to a conductor 40.

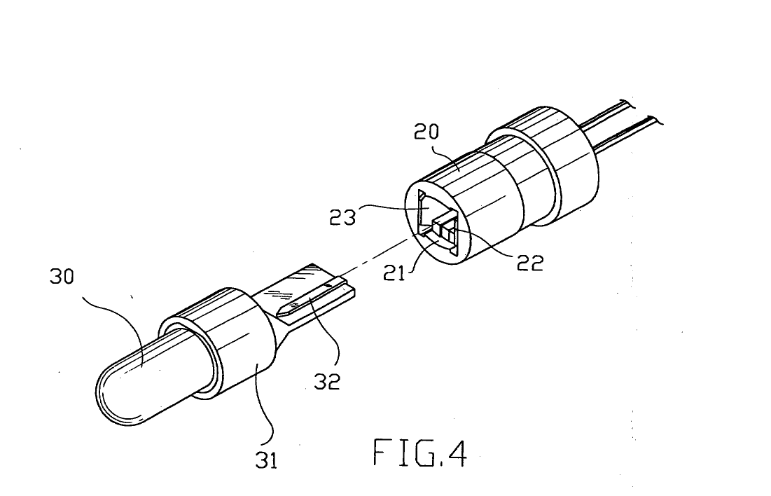

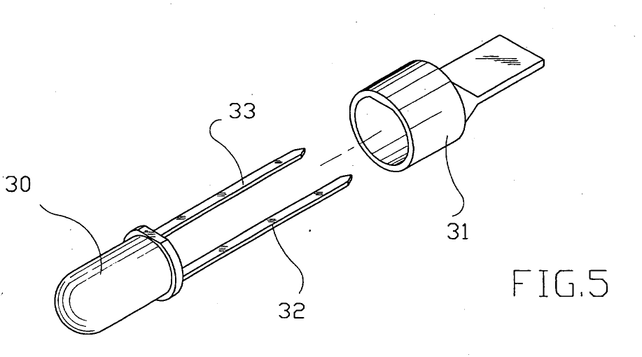

Please refer to FIG. 4 that is a disassembled perspective view of the LED lamp 30 and the LED lamp base 20, and to FIG. 5 that is an exploded perspective view of the LED lamp 30. As shown, the LED lamp 30 is fitted in a rigid insulating holder 31 and has two rear contact pins 32, 33 exposed from a rear end of the insulating holder 31. The LED lamp base 20 defines a socket 21 adapted to receive a rear part of the insulating holder 31 therein. The socket 21 is provided at two opposite sides with two contact plates 22, 23. When the insulating holder 31 of the LED lamp 30 is inserted into the socket 21 of the LED lamp base 20, the two contact pins 32, 33 of the LED lamp 30 are in contact with the two contact plates 22, 23 to electrically connect the LED lamp 30 to the LED lamp base 20.

In practical applications of the present invention, the LED lamps 30 may be connected in parallel, or alternatively, a group of two serially connected LED lamps 30 may be then parallelly connected to another group of two serially connected LED lamps 30, depending on the number of the LED lamps 30. When there is any individual LED lamp 30 in the taillight that does not emit light or does not emit light normally, simply replace the failed LED lamp 30 to complete the repair of the taillight. In the case the LED lamps 30 are in serial-parallel connection, the repair of any failed LED lamp 30 may still be conveniently completed simply by replacing one more LED lamp 30 serially connected to the failed one.

The LED lamp base 20 is made of a rubber material, which enables the LED lamp base 20 to be compressed and plugged into the insertion hole 13 on the pan 10 to tightly press against the insertion hole 13 and thereby produces a leak-proof effect. Meanwhile, the insulating holder 31 of the LED lamp 30 and the socket 21 on the LED lamp base 20 are also connected to each other in a tight fit relation to provide the leak-proof effect.

Since the LED lamps 30 are electrically independent from one another, they could be individually replaced without influencing other ones. This design also enables a user to freely select different colors for the LED lamps 30 in the insertion holes 13, and the differently colored LED lamps 30 may be arranged into different patterns according to the user's preference, so that the taillight presents a unique and personalized style.

In brief, the taillight of the present invention has LED lamps that are independently mounted on the pan of the taillight and could therefore be individually replaced to complete necessary repair or maintenance thereof at reduced efforts, time, and money. Moreover, the LED lamps may be differently colored to show different and unique patterns.

What is claimed is:

1. A taillight with individually replaceable LED lamps, comprising a pan for said taillight, a plurality of LED lamps, and a plurality of LED lamp bases in the same number as that of said LED lamps;
said pan having a front opening that is closed with a transparent panel, and a bulb that is mounted on said pan at a predetermined position; said pan being provided with a plurality of insertion holes in the same number as that of said LED lamps, and each of said insertion holes having a front portion formed into a flared spotlight shade;
said LED lamps being individually plugged into said LED lamp bases in a one-to-one correspondence; and
each of said LED lamp bases being individually electrically connected at a rear end to a conductor, and individually plugged from a front end into one of said insertion holes on said pan in a one-to-one correspondence, such that a front head of said LED lamp plugged in said LED lamp base is projected into and centered at said spotlight shade of said insertion hole.

2. The taillight with individually replaceable LED lamps as claimed in claim 1, wherein each of said LED lamps is fitted in a rigid insulating holder, and includes two contact pins that rearward extend to expose from a rear end of said insulating holder, and wherein each of said LED lamp bases defines a socket adapted for said insulating holder to plug thereinto; said socket being provided at two opposite sides with two contact plates that are in contact with said two contact pins on said LED lamp when said LED lamp is plugged into said socket of said LED lamp base.

3. The taillight with individually replaceable LED lamps as claimed in claim 1, wherein said LED lamp base is made of a rubber material, such that said LED lamp base is compressible when being plugged into said insertion hole on said pan and therefore provides a leak-proof effect.
